(19) United States
(12) Patent Application Publication
(10) Pub. No.: US 2020/0278037 A1
(43) Pub. Date: Sep. 3, 2020

(54) PRESSURE CONTROL DEVICE

(71) Applicant: NIDEC TOSOK CORPORATION, Kanagawa (JP)

(72) Inventor: Masaru MIYAGI, Kanagawa (JP)

(73) Assignee: NIDEC TOSOK CORPORATION, Kanagawa (JP)

(21) Appl. No.: 16/794,179

(22) Filed: Feb. 18, 2020

(30) Foreign Application Priority Data
Feb. 28, 2019 (JP) 2019-035167

(51) Int. Cl. F16K 11/07; B01D 29/31

(52) U.S. Cl. CPC F16K 11/0708; B01D 2201/291; B01D 29/31

(57) ABSTRACT

A pressure control device includes: a body having a groove-shaped flow path including a groove part and a widened part connected to the groove part and having a width larger than a width of the groove part; and a filter unit accommodated in the widened part to intercept the groove-shaped flow path and capturing foreign matters mixed in a fluid passing through the groove-shaped flow path. The filter unit includes: a filter member in a cylindrical shape whose central axis is along a depth direction of the widened part; and a cap attached to the filter member on one end side in the central axis direction and having a defining part defining a circumferential-direction disposition position of the filter member to the groove part.

The present invention claims priority under 35 U.S.C. § 119 to Japanese Application No. 2019-035167 filed on Feb. 28, 2019 the entire content of which is incorporated herein by reference.

### BACKGROUND

### Technical Field

The disclosure relates to a pressure control device.

### Description of Related Art

Regarding an oil pressure control device for controlling an oil pressure, for example, an oil pressure control device mounted on an automobile for the clutch is known.

Further, in general, in an oil pressure control device, when a filter is inserted into a flow path of a body and these members are assembled together to manufacture the oil pressure control device, the assembly work is often performed manually, for example.

It should be noted that the introduction in Background is merely provided for the convenience of clearly and comprehensively describing the technical solutions of the disclosure and facilitating the understanding of those skilled in the art. These technical solutions shall not be deemed well-known by those skilled in the art simply for having been described in Background.

However, the thinner the flow path is (that is, the smaller the width of the flow path is), the more difficult it is to perform the insertion work of the filter into the flow path. Therefore, there has been a problem that the efficiency of assembly work of the body and the filter is low.

### SUMMARY

In one embodiment of the disclosure, a pressure control device of the disclosure includes: a body which has a groove-shaped flow path including a groove part and a widened part connected to the groove part and having a width larger than a width of the groove part; and a filter unit which is accommodated in the widened part to intercept the groove-shaped flow path and which captures foreign matters mixed in a fluid passing through the groove-shaped flow path, wherein the filter unit includes: a filter member which is in a cylindrical shape whose central axis is along a depth direction of the widened part; and a cap which is attached to the filter member on one end side in a direction of the central axis and which has a defining part that defines a disposition position of the filter member with respect to the groove part in a circumferential direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing an embodiment of a pressure control device of the disclosure.

FIG. 2 is an exploded perspective view of the pressure control device shown in FIG. 1.

FIG. 3 is a cross-sectional view taken along the line in FIG. 1.

FIG. 4 is a view of the pressure control device shown in FIG. 1 as viewed from the front side.

FIG. 5 is a perspective view showing a part of the pressure control device shown in FIG. 1.

FIG. 6 is an exploded perspective view of a part of the pressure control device shown in FIG. 5.

FIG. 7 is a cross-sectional view taken along the line VII-VII in FIG. 5.

FIG. 8 is a transverse sectional view of a part of the pressure control device shown in FIG. 5.

FIG. 9 is a transverse sectional view of a part of the pressure control device shown in FIG. 5.

### DESCRIPTION OF THE EMBODIMENTS

The foregoing and other features of the disclosure will become apparent from the following specification with reference to the accompanying drawings. Specific embodiments of the disclosure are disclosed in the specification and the accompanying drawings. The specification and the accompanying drawings describe several embodiments to which the principles of the disclosure are applicable. However, it should be understood that, the disclosure is not limited to the embodiments described herein, but shall include all modifications, variations and equivalents falling within the scope of the appended claims.

Hereinafter, a pressure control device of the disclosure will be described in detail based on preferred embodiments shown in the accompanying drawings.

In each drawing, the Z-axis direction is the vertical direction Z. The X-axis direction is the left-right direction X in the horizontal direction orthogonal to the vertical direction Z. The Y-axis direction is the axial direction Y orthogonal to the left-right direction X in the horizontal direction orthogonal to the vertical direction Z. The positive side in the vertical direction Z is referred to as “the upper side,” and the negative side is referred to as “the lower side.” The positive side in the axial direction Y is referred to as “the front side,” and the negative side is referred to as “the rear side.” The front side corresponds to the one side in the axial direction, and the rear side corresponds to the other side in the axial direction. In the embodiment, the depth direction of a groove part is the vertical direction, and this is the Z-axis direction. Moreover, the width direction of the groove part orthogonal to the Z-axis direction is the X-axis direction. Further, the length direction (longitudinal direction) of the groove part (that is, a flow direction of a fluid) orthogonal to the Z-axis direction and the X-axis direction, respectively, is the Y-axis direction. Further, the upper side, the lower side, the front side, the rear side, the vertical direction, and the left-right direction are simply names for describing the relative positional relationship of each part, and the actual dispositional relationship and the like may be a dispositional relationship and the like other than the dispositional relationship and the like indicated by these names. Further, a “plan view” refers to a state viewed from the upper side toward the lower side.

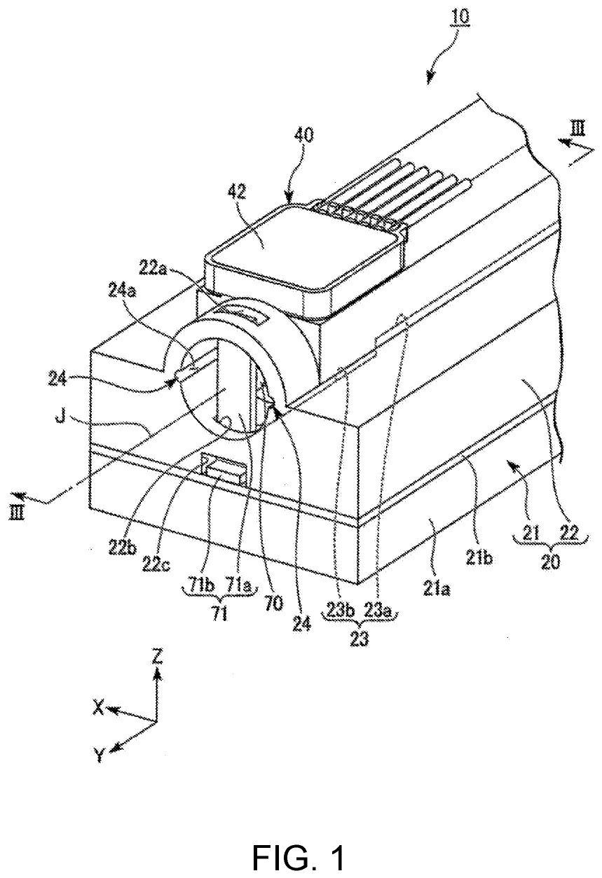

Hereinafter, an embodiment of the pressure control device of the disclosure will be described with reference to FIGS. 1 to 9.

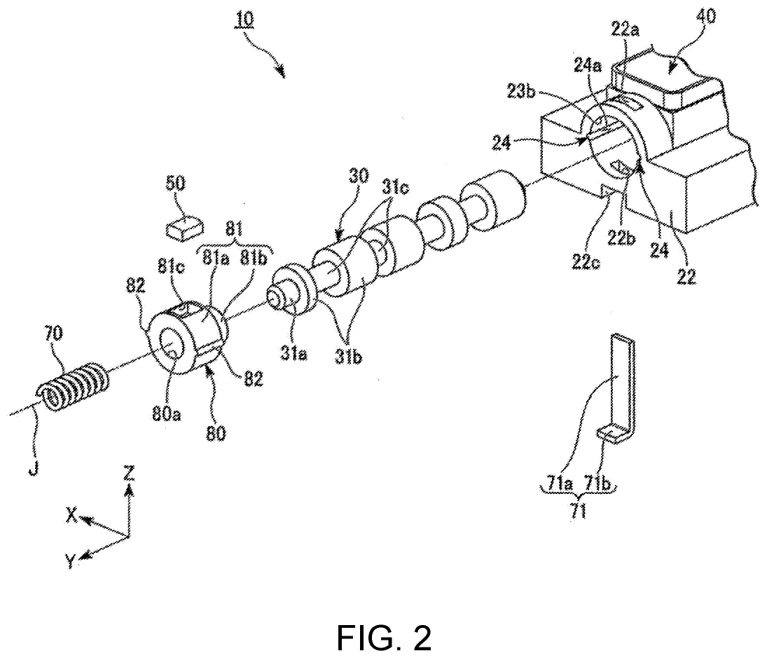

A pressure control device 10 of the embodiment shown in FIGS. 1 and 2 is, for example, a control valve mounted on a vehicle. The pressure control device 10 includes an oil passage body 20, a spool valve 30, a magnet holder 80, a magnet 50, an elastic member 70, a fixing member 71, and a sensor module 40.

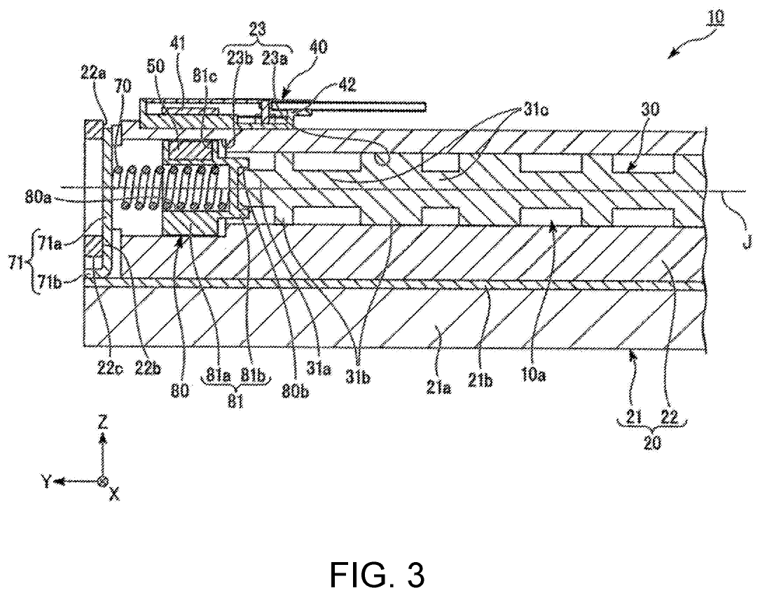

As shown in FIG. 3, the oil passage body 20 includes therein an oil passage 10a through which oil flows. The part of the oil passage 10a indicated in FIG. 3 is a part of a spool hole 23 (to be described later). Each drawing shows a state in which a part of the oil passage body 20 is cut out, for example. As shown in FIG. 1, the oil passage body 20 includes a lower body 21 and an upper body 22. Though omitted in the drawings, for example, the oil passage 10a is provided in both the lower body 21 and the upper body 22.

The lower body 21 includes a lower body main body 21a and a separate plate 21b disposed to overlap the upper side of the lower body main body 21a. In the embodiment, the upper surface of the lower body 21 corresponds to the upper surface of the separate plate 21b and is orthogonal to the vertical direction Z. The upper body 22 is disposed to overlap the upper side of the lower body 21. The lower surface of the upper body 22 is orthogonal to the vertical direction Z. The lower surface of the upper body 22 contacts the upper surface of the lower body 21, that is, the upper surface of the separate plate 21b.

As shown in FIG. 3, the upper body 22 includes the spool hole 23 extending in the axial direction Y. In the embodiment, the cross-sectional shape of the spool hole 23 orthogonal to the axial direction Y is a circular shape with a central axis J as the center. The central axis J extends in the axial direction Y. Further, a radial direction with the central axis J as the center is simply referred to as “the radial direction,” and a circumferential direction with the central axis J as the center is simply referred to as “the circumferential direction.”

The spool hole 23 opens at least on the front side. In the embodiment, the rear end of the spool hole 23 is closed. That is, the spool hole 23 is a hole that opens on the front side and has a bottom part. Further, the spool hole 23 may open on both sides in the axial direction Y, for example. At least a part of the spool hole 23 forms a part of the oil passage 10a in the oil passage body 20.

The spool hole 23 includes a spool hole main body 23a and a guiding hole part 23b. Though omitted in the drawings, the oil passage 10a provided in a part other than the spool hole 23 in the oil passage body 20 opens on the inner circumferential surface of the spool hole main body 23a. The inner diameter of the guiding hole part 23b is larger than the inner diameter of the spool hole main body 23a. The guiding hole part 23b is connected to the front-side end part of the spool hole main body 23a. The guiding hole part 23b is the front-side end part of the spool hole 23 and opens on the front side.

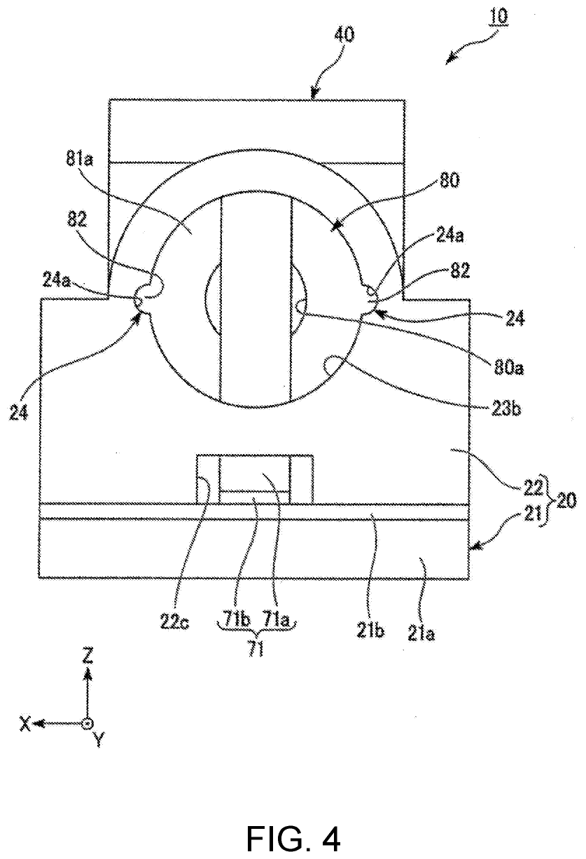

As shown in FIG. 1, the spool hole 23 includes a groove part 24 that is recessed from the inner circumferential surface of the spool hole 23 toward the outer side in the radial direction and extends in the axial direction Y. In the embodiment, a pair of groove parts 24 are provided across the central axis J. The pair of groove parts 24 are recessed from the inner circumferential surface of the guiding hole part 23b toward both sides in the left-right direction X. The groove part 24 is provided from the front-side end part on the inner circumferential surface of the guiding hole part 23b to the rear-side end part on the inner circumferential surface of the guiding hole part 23b. As shown in FIG. 4, an inner side surface 24a of the groove part 24 is in a semicircular arc shape that is concave from the inner circumferential surface of the guiding hole part 23b toward the outer side in the radial direction when viewed from the front side.

As shown in FIG. 3, the upper body 22 includes through holes 22a, 22b, 22c at the front-side end part of the upper body 22. The through hole 22a penetrates a part in the upper body 22 from the upper surface of the upper body 22 to the inner circumferential surface of the guiding hole part 23b in the vertical direction Z. The through hole 22b penetrates a part in the upper body 22 from the lower surface of the upper body 22 to the inner circumferential surface of the guiding hole part 23b in the vertical direction Z. As shown in FIG. 1, the through hole 22a and the through hole 22b are in a rectangular shape that is long in the left-right direction X when viewed from the upper side. The through hole 22a and the through hole 22b overlap each other when viewed from the upper side.

As shown in FIG. 3, the through hole 22c penetrates a part in the upper body 22 from the front surface of the upper body 22 to the through hole 22b in the axial direction Y. The through hole 22c is provided at the lower end part of the front surface of the upper body 22. The through hole 22c opens on the lower side. As shown in FIG. 4, the through hole 22c is in a rectangular shape that is long in the left-right direction X when viewed from the front side. The centers of the through holes 22a, 22b, 22c in the left-right direction X are, for example, the same as the position of the central axis J in the left-right direction X.

As shown in FIG. 1, the part of the upper body 22 where the spool hole 23 is provided protrudes further to the upper side than the other part of the upper body 22. The upper surface at the front-side end part of this protruding part is a curved surface in a semicircular arc shape convex toward the upper side. The through hole 22a opens at the upper end part of the curved surface in a semicircular arc shape. The lower body main body 21a, the separate plate 21b, and the upper body 22 are each a single member, for example. The lower body main body 21a, the separate plate 21b, and the upper body 22 are made of a nonmagnetic material.

As shown in FIG. 3, the spool valve 30 is disposed along the central axis J extending in the axial direction Y that intersects the vertical direction Z. The spool valve 30 is in a circular columnar shape. The spool valve 30 is attached to the oil passage body 20. The spool valve 30 is disposed to be movable in the axial direction Y within the spool hole 23.

The spool valve 30 moves in the axial direction Y within the spool hole main body 23a, and opens and closes the opening part of the oil passage 10a that opens on the inner circumferential surface of the spool hole main body 23a. Though omitted in the drawings, a forward force from oil pressure of the oil or a driving device such as a solenoid actuator is applied to the rear-side end part of the spool valve 30. The spool valve 30 includes a supporting part 31a, a plurality of large diameter parts 31b, and a plurality of small diameter parts 31c. Each part of the spool valve 30 is in a circular columnar shape extending in the axial direction Y with the central axis J as the center.

The supporting part 31a is the front-side end part of the spool valve 30. The front-side end part of the supporting part 31a supports the rear-side end part of the magnet holder 80. The rear-side end part of the supporting part 31a is connected to the front-side end part of the large diameter part 31b.

The plurality of large diameter parts 31b and the plurality of small diameter parts 31c are alternately and continuously disposed from the large diameter part 31b connected to the rear-side end part of the supporting part 31a toward the rear side. The outer diameter of the large diameter part 31b is larger than the outer diameter of the small diameter part 31c. In the embodiment, the outer diameter of the supporting part 31a and the outer diameter of the small diameter part 31c are, for example, equal. The outer diameter of the large diameter part 31b is substantially equal to the inner diameter of the spool hole main body 23a, and is slightly smaller than the inner diameter of the spool hole main body 23a. The large diameter part 31b is movable in the axial direction Y while sliding with respect to the inner circumferential surface of the spool hole main body 23a. The large diameter part 31b functions as a valve part that opens and closes the opening part of the oil passage 10a that opens on the inner circumferential surface of the spool hole main body 23a. In the embodiment, the spool valve 30 is, for example, a single member made of metal.

The magnet holder 80 is disposed on the front side of the spool valve 30. The magnet holder 80 is disposed inside the guiding hole part 23b to be movable in the axial direction Y. The spool valve 30 and the magnet holder 80 are allowed to rotate relative to each other around the central axis. As shown in FIG. 2, the magnet holder 80 includes a holder main body part 81 and a facing part 82.

The holder main body part 81 is in a stepped circular columnar shape extending in the axial direction Y with the central axis J as the center. As shown in FIG. 3, the holder main body part 81 is disposed in the spool hole 23. More specifically, the holder main body part 81 is disposed in the guiding hole part 23b. The holder main body part 81 includes a sliding part 81a and a supported part 81b. That is, the magnet holder 80 includes the sliding part 81a and the supported part 81b.

The outer diameter of the sliding part 81a is larger than the outer diameter of the large diameter part 31b. The outer diameter of the sliding part 81a is substantially equal to the inner diameter of the guiding hole part 23b, and is slightly smaller than the inner diameter of the guiding hole part 23b. The sliding part 81a is movable in the axial direction Y while sliding with respect to the inner circumferential surface of the spool hole 23, that is, the inner circumferential surface of the guiding hole part 23b in the embodiment. The outer edge part in the radial direction of the rear-side surface of the sliding part 81a can contact a front-side-facing step surface of a step formed between the spool hole main body 23a and the guiding hole part 23b. In this way, the magnet holder 80 can be suppressed from moving from the position where the magnet holder 80 contacts the step surface toward the rear side, and the furthest rear end position of the magnet holder 80 can be determined. As will be described later, since the spool valve 30 receives a backward force from the elastic member 70 via the magnet holder 80, the furthest rear end position of the spool valve 30 can be determined by determining the furthest rear end position of the magnet holder 80.

The supported part 81b is connected to the rear-side end part of the sliding part 81a. The outer diameter of the supported part 81b is smaller than the outer diameter of the sliding part 81a and the outer diameter of the large diameter part 31b, and larger than the outer diameter of the supporting part 31a and the outer diameter of the small diameter part 31c. The supported part 81b is movable in the spool hole main body 23a. The supported part 81b moves in the axial direction Y between the guiding hole part 23b and the spool hole main body 23a as the spool valve 30 moves in the axial direction Y.

The supported part 81b includes a supported concave part 80b that is recessed from the rear-side end part of the supported part 81b toward the front side. The supporting part 31a is inserted into the supported concave part 80b. The front-side end part of the supporting part 31a contacts the bottom surface of the supported concave part 80b. In this way, the magnet holder 80 is supported by the spool valve 30 from the rear side. The size of the supported part 81b in the axial direction Y is smaller than the size of the sliding part 81a in the axial direction Y, for example.

As shown in FIG. 2, the facing part 82 protrudes from the holder main body part 81 toward the outer side in the radial direction. More specifically, the facing part 82 protrudes from the sliding part 81a toward the outer side in the radial direction. In the embodiment, a pair of facing parts 82 are provided across the central axis J. The pair of facing parts 82 protrude from the outer circumferential surface of the sliding part 81a toward both sides in the left-right direction X. The facing part 82 extends in the axial direction Y from the front-side end part of the sliding part 81a to the rear-side end part of the sliding part 81a. As shown in FIG. 4, the facing part 82 is in a semicircular arc shape that is convex toward the outer side in the radial direction when viewed from the front side.

The pair of facing parts 82 are fitted in the pair of groove parts 24. The facing part 82 faces the inner side surface 24a of the groove part 24 in the circumferential direction and can contact the inner side surface 24a. In addition, in the specification, that “two certain parts face each other in the circumferential direction” includes that both of the two parts are located on one virtual circle along the circumferential direction and that the two parts face each other.

As shown in FIG. 3, the magnet holder 80 includes a first concave part 81c that is recessed from the outer circumferential surface of the sliding part 81a toward the inner side in the radial direction. In FIG. 3, the first concave part 81c is recessed from the upper end part of the sliding part 81a toward the lower side. The inner side surfaces of the first concave part 81c include a pair of surfaces facing the axial direction Y.

The magnet holder 80 includes a second concave part 80a that is recessed from the front-side end part of the magnet holder 80 toward the rear side. The second concave part 80a extends from the sliding part 81a to the supported part 81b. As shown in FIG. 2, the second concave part 80a is in a circular shape with the central axis J as the center when viewed from the front side. As shown in FIG. 3, the inner diameter of the second concave part 80a is larger than the inner diameter of the supported concave part 80b.

For example, the magnet holder 80 may be made of resin or made of metal. In the case where the magnet holder 80 is made of resin, the magnet holder 80 can be easily manufactured. Moreover, the manufacturing cost of the magnet holder 80 can be reduced. In the case where the magnet holder 80 is made of metal, the size accuracy of the magnet holder 80 can be improved.

As shown in FIG. 2, the magnet 50 is in a substantially rectangular parallelepiped shape. The upper surface of the magnet 50 is, for example, a surface that is curved in an arc shape along the circumferential direction. As shown in FIG. 3, the magnet 50 is accommodated in the first concave part 81c and fixed to the holder main body part 81. In this way, the magnet 50 is fixed to the magnet holder 80. The magnet 50 is fixed by, for example, an adhesive. The outer side surface in the radial direction of the magnet 50 is located, for example, closer to the inner side in the radial direction than the outer circumferential surface of the sliding part 81a. The outer side surface in the radial direction of the magnet 50 faces the inner circumferential surface of the guiding hole part 23b in the radial direction with a gap therebetween.

As described above, the sliding part 81a provided with the first concave part 81c moves while sliding with respect to the inner circumferential surface of the spool hole 23. Therefore, the outer circumferential surface of the sliding part 81a and the inner circumferential surface of the spool hole 23 contact each other or face each other with a slight gap therebetween. As a result, it is difficult for foreign matters such as metal pieces contained in the oil to enter the first concave part 81c. Therefore, foreign matters such as metal pieces contained in the oil can be suppressed from attaching to the magnet 50 accommodated in the first concave part 81c. In the case where the magnet holder 80 is made of metal, since the size accuracy of the sliding part 81a can be improved, it is more difficult for the foreign matters such as metal pieces contained in the oil to enter the first concave part 81c.

As shown in FIG. 2, the fixing member 71 is in a plate shape whose plate surfaces are parallel to the left-right direction X. The fixing member 71 includes an extending part 71a and a bent part 71b. The extending part 71a extends in the vertical direction Z. The extending part 71a is in a rectangular shape that is long in the vertical direction Z when viewed from the front side. As shown in FIGS. 1 and 3, the extending part 71a is inserted into the guiding hole part 23b through the through hole 22b. The upper end part of the extending part 71a is inserted into the through hole 22a. The extending part 71a closes a part of the opening of the guiding hole part 23b on the front side. The bent part 71b is bent from the lower-side end part of the extending part 71a toward the front side. The bent part 71b is inserted into the through hole 22c. The fixing member 71 is disposed on the front side of the elastic member 70.

In the embodiment, the fixing member 71 is inserted to the through hole 22a from the opening part of the through hole 22b, which opens on the lower surface of the upper body 22, through the through hole 22b and the guiding hole part 23b before the upper body 22 and the lower body 21 are overlapped. Then, as shown in FIG. 1, the upper body 22 and the lower body 21 are stacked and combined in the vertical direction Z, whereby the bent part 71b inserted in the through hole 22c can be supported by the upper surface of the lower body 21 from the lower side. In this way, the fixing member 71 can be attached to the oil passage body 20.

As shown in FIG. 3, the elastic member 70 is a coil spring extending in the axial direction Y. The elastic member 70 is disposed on the front side of the magnet holder 80. In the embodiment, at least a part of the elastic member 70 is disposed in the second concave part 80a. Therefore, at least a part of the elastic member 70 can be overlapped with the magnet holder 80 in the radial direction, and the size of the pressure control device 10 in the axial direction Y can be easily reduced. In the embodiment, the rear-side part of the elastic member 70 is disposed in the second concave part 80a.

The rear-side end part of the elastic member 70 contacts the bottom surface of the second concave part 80a. The front-side end part of the elastic member 70 contacts the fixing member 71. In this way, the front-side end part of the elastic member 70 is supported by the fixing member 71. The fixing member 71 receives a forward elastic force from the elastic member 70, and the extending part 71a is pressed against the front-side inner side surfaces of the through holes 22a, 22b.

By supporting the front-side end part of the elastic member 70 by the fixing member 71, the elastic member 70 applies a backward elastic force to the spool valve 30 via the magnet holder 80. Therefore, for example, the position of the spool valve 30 in the axial direction Y can be maintained at a position where the oil pressure of the oil or the force from a driving device such as a solenoid actuator applied to rear-side end part of the spool valve 30 and the elastic force of the elastic member 70 are balanced. In this way, the position of the spool valve 30 in the axial direction Y can be changed by changing the force applied to the rear-side end part of the spool valve 30, and the oil passage 10a inside the oil passage body 20 can be switched between opening and closing.

Further, the magnet holder 80 and the spool valve 30 can be pressed against each other in the axial direction Y by the oil pressure of the oil or the force from a driving device such as a solenoid actuator applied to rear-side end part of the spool valve 30 and the elastic force of the elastic member 70. Therefore, the magnet holder 80 moves in the axial direction Y as the spool valve 30 moves in the axial direction Y while relative rotation around the central axis with respect to the spool valve 30 is allowed.

The sensor module 40 includes a housing 42 and a magnetic sensor 41. The housing 42 accommodates the magnetic sensor 41. As shown in FIG. 1, the housing 42 is, for example, in a rectangular parallelepiped box shape flat in the vertical direction Z. The housing 42 is fixed to a flat surface located on the rear side of the curved surface in a semicircular arc shape, where the through hole 22a is provided, on the upper surface of the upper body 22.

As shown in FIG. 3, the magnetic sensor 41 is fixed to the bottom surface of the housing 42 inside the housing 42. In this way, the magnetic sensor 41 is attached to the oil passage body 20 via the housing 42. The magnetic sensor 41 detects the magnetic field of the magnet 50. The magnetic sensor 41 is, for example, a Hall element. Further, the magnetic sensor 41 may be a magnetoresistive element.

When the position of the magnet 50 in the axial direction Y changes as the spool valve 30 moves in the axial direction Y, the magnetic field of the magnet 50 passing through the magnetic sensor 41 changes. Therefore, by detecting the change in the magnetic field of the magnet 50 by the magnetic sensor 41, the position of the magnet 50 in the axial direction Y (that is, the position of the magnet holder 80 in the axial direction Y) can be detected. As described above, the magnet holder 80 moves in the axial direction Y as the spool valve 30 moves in the axial direction Y. Therefore, the position of the spool valve 30 in the axial direction Y can be detected by detecting the position of the magnet holder 80 in the axial direction Y.

The magnetic sensor 41 and the magnet 50 overlap in the vertical direction Z. That is, at least a part of the magnet 50 overlaps the magnetic sensor 41 in a direction parallel to the vertical direction Z in the radial direction. Therefore, the magnetic sensor 41 can easily detect the magnetic field of the magnet 50. As a result, the sensor module 40 can detect the position change of the magnet holder 80 in the axial direction Y (that is, the position change of the spool valve 30 in the axial direction Y) with higher accuracy.

In addition, in the specification, that “at least a part of the magnet overlaps the magnetic sensor in the radial direction” means that at least a part of the magnet may overlap the magnetic sensor in the radial direction in at least some positions within the range in which the spool valve to which the magnet is directly fixed moves in the axial direction. That is, for example, when the spool valve 30 and the magnet holder 80 change the positions in the axial direction Y from the positions of FIG. 3, the magnet 50 may not overlap the magnetic sensor 41 in the vertical direction Z. In the embodiment, a part of the magnet 50 overlaps the magnetic sensor 41 in the vertical direction Z at any position as long as the spool valve 30 is within the range in which the spool valve 30 moves in the axial direction Y.

The pressure control device 10 further includes a rotation stopping part. The rotation stopping part is a part that can contact the magnet holder 80. In the embodiment, the rotation stopping part is the inner side surface 24a of the groove part 24. That is, the facing part 82 faces the inner side surface 24a, which is the rotation stopping part, in the circumferential direction and can contact the inner side surface 24a.

Therefore, according to the embodiment, for example, when the facing part 82 tries to rotate around the central axis J, the facing part 82 contacts the inner side surface 24a, which is the rotation stopping part. As a result, rotation of the facing part 82 is suppressed by the inner side surface 24a, and rotation of the magnet holder 80 around the central axis J is suppressed. As a result, the position of the magnet 50 fixed to the magnet holder 80 can be suppressed from shifting in the circumferential direction. Therefore, even when the spool valve 30 rotates around the central axis J when the position of the spool valve 30 in the axial direction Y does not change, the information of the position of the magnet 50 in the axial direction Y detected by the magnetic sensor 41 can be suppressed from changing. In this way, the information of the position of the spool valve 30 can be suppressed from changing, and the accuracy of grasping the position of the spool valve 30 in the axial direction Y can be improved.

Further, according to the embodiment, the rotation stopping part is the inner side surface 24a of the groove part 24. Therefore, it is not necessary to prepare a separate member as the rotation stopping part, and the number of components of the pressure control device 10 can be reduced. In this way, the effort required for the assembly of the pressure control device 10 and the manufacturing cost of the pressure control device 10 can be reduced.

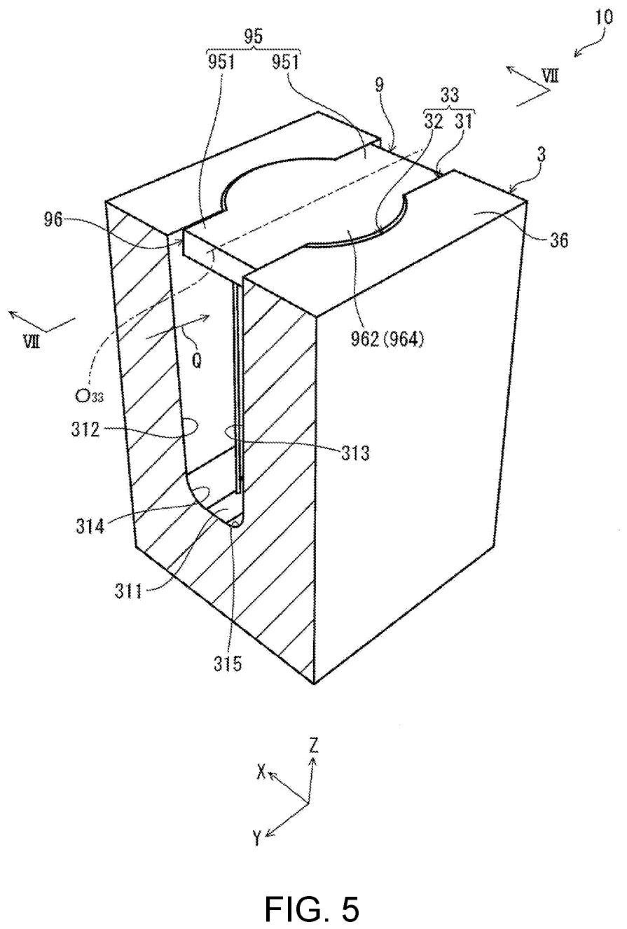

As described above, the oil passing through the pressure control device 10 may contain foreign matters such as metal pieces. It is preferable that such foreign matters are captured in the course of the oil passing through the pressure control device 10 and are prevented from flowing further to the downstream side. Therefore, the pressure control device 10 is configured to be capable of capturing foreign matters. Hereinafter, this configuration and operation will be described with reference to FIGS. 5 to 9.

In addition, though the pressure control device 10 is applied to an oil pressure control device which controls the pressure of oil in the embodiment, it is not limited thereto. Examples of devices to which the pressure control device 10 can be applied include fluid devices such as a water pressure control device that controls the pressure of water and an air pressure control device that controls the pressure of air in addition to an oil pressure control device. In this case, things that pass through the pressure control device 10 include fluids such as oil, water, and air, and these are collectively referred to as a “fluid” in the following description. Further, the direction in which the fluid flows is referred to as a “flow direction Q.”

In addition to the spool valve 30, the magnet holder 80, the magnet 50, the elastic member 70, the fixing member 71, the sensor module 40 and the like described above, the pressure control device 10 further includes a filter unit 9 attached to a body 3 as shown in FIG. 5.

The body 3 may be at least one of the lower body 21 and the upper body 22 that form the oil passage body 20. As shown in FIGS. 5 to 7, the body 3 includes a groove-shaped flow path 33 which is provided in a recessed manner on an upper surface (surface) 36 and through which the fluid passes. The groove-shaped flow path 33 includes a groove part 31 and a widened part 32 connected to the groove part 31, and the groove-shaped flow path 33 forms a part of the oil passage 10a.

The groove part 31 includes a bottom part (first bottom part) 311 and, when viewed from upstream to downstream of the flow of the fluid, a side wall part 312 located on one side of the bottom part 311 and a side wall part 313 located on the other side of the bottom part 311. In addition, it is preferable that a boundary part 314 between the bottom part 311 and the side wall part 312 and a boundary part 315 between the bottom part 311 and the side wall part 313 are rounded as shown in FIG. 5. In this way, the fluid can smoothly pass through the vicinity of the boundary part 314 and the boundary part 315.

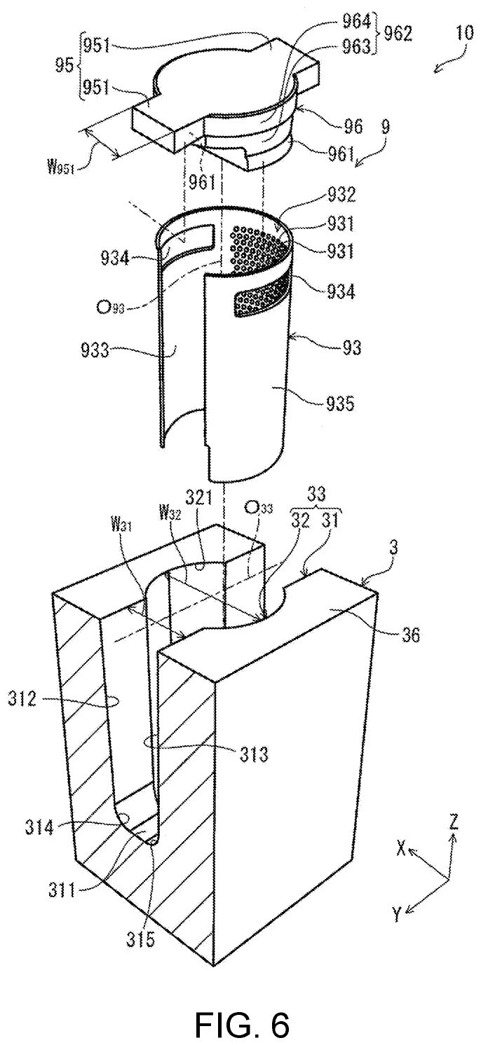

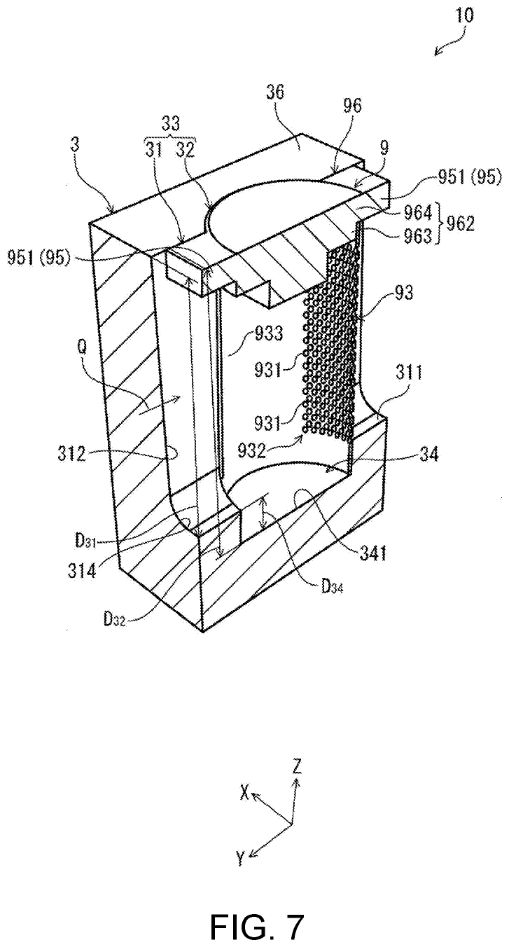

The groove part 31 is in a linear shape along the axial direction Y in the plan view of the body 3, but it is not limited thereto, and the groove part 31 may include at least a part that is curved. A width (first width) W31 (with reference to FIG. 6) of the groove part 31, which is the distance between the side wall part 312 and the side wall part 313, is substantially constant along the axial direction Y. Further, a depth (first depth) D31 (with reference to FIG. 7) of the groove part 31, which is the depth from the surface 36 to the bottom part 311, is also substantially constant along the axial direction Y.

The widened part 32 is provided in the longitudinal direction of the groove-shaped flow path 33, that is, in the middle in the axial direction Y. The widened part 32 extends from the surface 36 to the bottom part 311, has a width W32 larger than the width W31 of the groove part 31, and functions as an accommodating part in which the filter unit 9 in a cylindrical shape is accommodated. The width W32 (with reference to FIG. 6) of the widened part 32 gradually increases from the upstream side to the downstream side (that is, from the front side to the rear side), and gradually decreases from the middle toward the downstream side. Specifically, in the embodiment, the widened part 32 includes a curved part 321 that is curved in an arc shape in the plan view.

The widened part 32 in such a shape can be processed by an end mill, for example.

As shown in FIG. 7, the widened part 32 has a depth (second depth) D32 from the surface 36 to a bottom surface (second bottom part) 341 while maintaining the width W32 constant along the vertical direction Z, and the depth D₃₂ is larger than the depth D₃₁ of the groove part 31. The widened part 32 includes, on the bottom part thereof, a receiving part 34 which a part of the filter unit 9 (the filter member 93) on the lower side enters. In this way, for example, foreign matters mixed in the fluid can be prevented from bypassing the filter unit 9 and flowing to the downstream side. Further, of course, a depth D₃₄ of the receiving part 34 is equal to the difference between the depth D₃₂ and the depth D₃₁.

As shown in FIGS. 6 and 7, the filter unit 9 is accommodated in the widened part 32 so that the direction of a central axis O₉₃ of the filter member 93 is along the direction of the depth D₃₂ of the widened part 32 (that is, the vertical direction Z). The filter unit 9 can capture the foreign matters mixed in the fluid when the fluid passes through the groove-shaped flow path 33. In this way, for example, the malfunction of operation of the pressure control device 10 caused by foreign matters can be prevented or suppressed. Examples of the malfunction include inhibition of movement of the spool valve 30 when it moves in the spool hole 23.

As shown in FIGS. 5 to 7, the filter unit 9 includes the filter member 93 and a cap 96 attached to the filter member 93.

The filter member 93 is a member in which a plate material is formed in a circular cylindrical shape so that the central axis O₉₃ is along the direction of the depth D₃₂ of the widened part 32. Then, as described above, in the pressure control device 10, the filter member 93 can be accommodated in the widened part 32 so that the direction of its central axis O₉₃ is along the direction of the depth D₃₂ of the widened part 32. In this way, the filter member 93 is accommodated in the widened part 32 to intercept the groove-shaped flow path 33 and thus can capture the foreign matters mixed in the fluid passing through the groove-shaped flow path 33. In addition, though the filter member 93 is in a circular cylindrical shape in the embodiment, it is not limited thereto, and it may be, for example, in an angular cylindrical shape or the like.

As shown in FIGS. 6 and 7, the filter member 93 has a small hole region 932 on one end side in the direction of the axis O₃₃ of the flow path 33 (that is, on the negative side in the axial direction Y), and has an open part 933 on the other end side in the direction of the axis O₃₃ of the flow path 33 (that is, on the positive side in the axial direction Y).

The small hole region 932 is a region provided with a plurality of small holes 931 penetrating in the thickness (plate thickness) direction of the filter member 93. The small holes 931 are disposed at intervals along both the circumferential direction of the filter member 93 and the vertical direction Z. The diameter of the small hole 931 is set to be smaller than an average foreign matter diameter, and it is preferable that the total area of the small holes 931 is as large as possible so as not to inhibit the flow of the fluid, and it is also preferable that the opening ratio is as large as possible. With such small holes 931, the foreign matter capturing property of the filter unit 9 is improved.

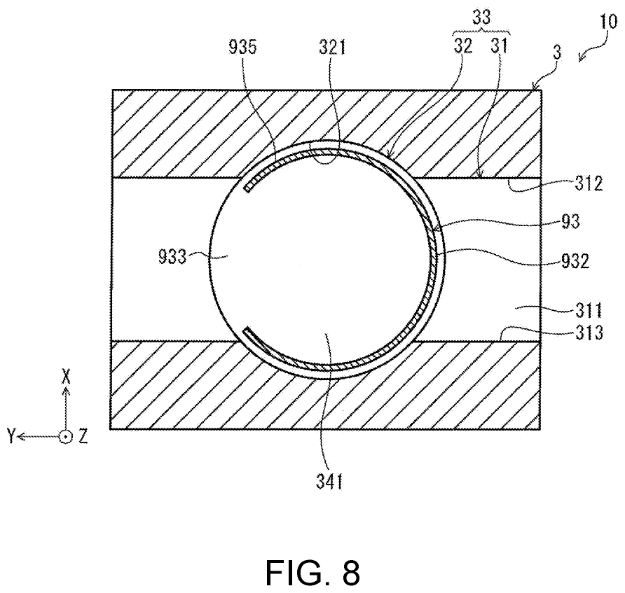

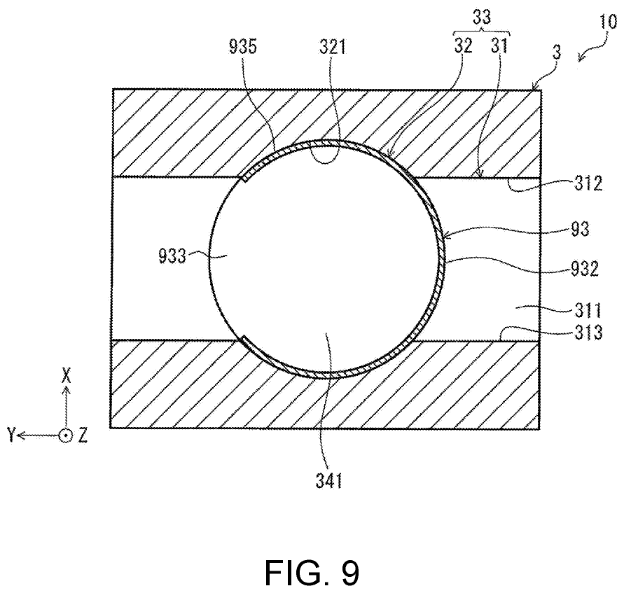

The open part 933 is a part where the other end side of the filter member 93 in the direction of the axis O₃₃ of the flow path 33 is open over the entire length in the direction of the central axis O₉₃. In this way, the filter member 93 can easily elastically deform in the radial direction. Due to such elastic deformation, as shown in FIG. 8, when the filter member 93 is accommodated in the widened part 32, the filter member 93 can contract toward the inner side in the radial direction to be smaller than the widened part 32. In this way, the accommodation work of the filter member 93 to the widened part 32 can be performed easily. Further, as shown in FIG. 9, the filter member 93 expands toward the outer side in the radial direction by a restoring force when accommodated in the widened part 32, that is, in the accommodated state of being accommodated in the widened part 32. In this way, the filter member 93 is moved toward the outer side in the radial direction, and its outer circumferential surface 935 contacts the curved part 321 of the widened part 32, and its posture within the widened part 32 is stabilized.

Therefore, when the body 3 and the filter member 93 are assembled, the filter member 93 can be appropriately elastically deformed until the accommodation of the filter member 93 into the widened part 32 of the body 3 is completed, whereby the assembly workability is improved.

Further, as described above, the filter member 93 is in a circular cylindrical shape. In this way, the filter member 93 can stably elastically deform in the radial direction. In addition, a “circular cylinder” has a shape that is durable against the flow of the fluid. In this way, when the fluid passes through the filter member 93, the filter member 93 is prevented from being deformed by the flow of the fluid, whereby the filter member 93 can reliably capture the foreign matters. As a result, the foreign matter capturing property of the filter unit 9 is further improved.

In addition, in the state shown in FIGS. 5 and 7, the flow direction Q of the fluid is a flow from the open part 933 side toward the small hole region 932 side of the filter member 93, that is, a flow toward the negative side in the axial direction Y. However, the flow direction Q is not limited thereto, and it may be a flow from the small hole region 932 side toward the open part 933 side of the filter member 93, that is, a flow toward the positive side in the axial direction Y.

As shown in FIGS. 5 to 7, the cap 96 is attached to the filter member 93 on the one end side in the direction of the central axis O₉₃, that is, on the positive side in the vertical direction Z. The cap 96 may be attached to the filter member 93 after the filter member 93 is accommodated in the widened part 32, or the cap 96 may be attached to the filter member 93 before the filter member 93 is accommodated in the widened part 32. In this case, when the filter member 93 is accommodated in the widened part 32, the cap 96 can be held, and the accommodation work can be performed easily and smoothly.

In addition, for example, it is preferable that the cap 96 is formed by an elastic material such as silicone rubber.

As shown in FIG. 6, the cap 96 includes a main body part 962 in a circular plate shape and a pair of claw parts 961 provided on the lower side of the main body part 962.

The main body part 962 includes a small diameter part 963 which has a diameter that changes along the vertical direction Z and which is located on the lower side, and includes a large diameter part 964 which is located on the upper side and which has a diameter that is larger than the diameter of the small diameter part 963.

The small diameter part 963 elastically deforms and is fitted inside the filter member 93.

The large diameter part 964 elastically deforms and is fitted inside the widened part 32. In this way, the filter unit 9 can be prevented from detaching from the widened part 32 when the body 3 and the filter unit 9 (the filter member 93) are assembled. Due to this detachment prevention effect, for example, even if the body 3 and the filter unit 9 in the assembly state are turned upside down, or even if vibration is applied during transportation, unintentional disassembly of the body 3 and the filter unit 9 when the filter unit 9 is detached from the widened part 32 can be prevented.

Each claw part 961 protrudes from the inner side in the radial direction of the filter member 93 toward the outer side. Further, the claw parts 961 protrude in directions opposite to each other; that is, one claw part 961 protrudes toward the positive side in the left-right direction X, and the other claw part 961 protrudes toward the negative side in the left-right direction X.

In addition, the filter member 93 includes two through holes 934. Each through hole 934 is provided between the small hole region 932 and the open part 933 of the filter member 93. Each claw part 961 of the cap 96 can enter the through hole 934 from the inner side of the filter member 93 toward the outer side. Then, due to this entry and the fitting of the small diameter part 963 to the filter member 93, the cap 96 is more securely attached to the filter member 93.

As shown in FIGS. 5 to 7, the cap 96 includes a defining part 95 which defines the disposition position of the filter member 93 with respect to the groove part 31 in the circumferential direction and which serves as a detent around the central axis O₉₃ of the filter member 93 in the state where the filter member 93 is accommodated in the widened part 32. Here, “defining the disposition position of the filter member 93 with respect to the groove part 31 in the circumferential direction” can mean “defining the direction of the filter member 93 around the central axis O₉₃.”

The defining part 95 is configured by a pair of protruding parts 951 which are provided on the large diameter part 964 of the cap 96 and which protrude in a block shape or a plate shape. The protruding parts 951 are respectively disposed on the upstream side and the downstream side of the groove-shaped flow path 33. In other words, one protruding part 951 of the protruding parts 951 is directed from the widened part 32 toward the groove part 31 located on the upstream side, that is, protrudes toward the front side in the axial direction Y, and the other protruding part 951 is directed from the widened part 32 toward the groove part 31 located on the downstream side, that is, protrudes toward the rear side in the axial direction Y.

Then, in the state where the filter member 93 is accommodated in the widened part 32, each protruding part 951 is disposed in the groove part 31. Further, at this time, each protruding part 951 may abut against at least one of the side wall part 312 and the side wall part 313 of the groove part 31. With the protruding parts 951 of this kind, the filter member 93 can be prevented from rotating in either the clockwise direction or the counterclockwise direction with the central axis O₉₃ as the center in the state of being accommodated in the widened part 32. In this way, even when the pressure control device 10 is in operation, the posture of the filter member 93 in the widened part 32 can be stabilized, and the small hole region 932 of the filter member 93 can face the flow direction Q of the fluid, and the filter member 93 can capture the foreign matters. Further, when the filter member 93 is accommodated in the widened part 32, the above-described disposition position of the filter member 93 with respect to the groove part 31 can be quickly grasped, whereby the assembly work of the body 3 and the filter unit 9 can be performed smoothly.

In addition, the defining part 95 can be configured by the protruding parts 951 having a simple shape, which contributes to high efficiency when the filter unit 9 is manufactured. Further, since the defining part 95 is provided on the cap 96, the defining part 95 can be disposed as close to the corner of the groove-shaped flow path 33 as possible, whereby the defining part 95 can be prevented or suppressed from inhibiting the flow of the fluid.

Further, the defining part 95 may not have the pair of protruding parts 951, and for example, one protruding part 951 may be omitted.

In addition, it is preferable that a width W951 of each protruding part 951 is somewhat smaller than the width W31 of the groove part 31.

Although the pressure control device of the disclosure has been described above with the embodiments of the drawings, the disclosure is not limited thereto. Each part which configures the pressure control device can be replaced with any configuration which can exhibit the same function. Moreover, any component may be added.

Furthermore, the plate-shaped member attached to the body is not limited to a plate (a separate plate), and it may be another body in which a flow path is formed.

The embodiments of the disclosure are described in detail with reference to the accompanying drawings, which illustrate the examples to which the principles of the disclosure are applicable. It should be understood that the embodiments of the disclosure are not limited to those described above, but shall cover all variations, modifications, and equivalents within the scope of the disclosure.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A pressure control device comprising:
a body which comprises a groove-shaped flow path comprising:
a groove part; and
a widened part connected to the groove part and having a width larger than a width of the groove part; and
a filter unit which is accommodated in the widened part to intercept the groove-shaped flow path and which captures foreign matters mixed in a fluid passing through the groove-shaped flow path,
wherein the filter unit comprises:
a filter member which is in a cylindrical shape whose central axis is along a depth direction of the widened part; and
a cap which is attached to the filter member on one end side in a direction of the central axis and which comprises a defining part that defines a disposition position of the filter member with respect to the groove part in a circumferential direction.

2. The pressure control device according to claim 1, wherein the defining part comprises a protruding part which protrudes from the widened part toward the groove part.

3. The pressure control device according to claim 2, wherein the protruding part is respectively disposed on an upstream side and a downstream side of the groove-shaped flow path.

4. The pressure control device according to claim 1, wherein the cap is formed by an elastic material.

5. The pressure control device according to claim 1, wherein the cap comprises a claw part which protrudes from an inner side in a radial direction of the filter member toward an outer side, and
the filter member comprises a through hole which the claw part enters.

6. The pressure control device according to claim 1, wherein the filter member comprises:
a small hole region, provided on one end side in an axial direction of the groove-shaped flow path, and is provided with a plurality of small holes penetrating in a thickness direction; and
an open part, provided on the other end side in the axial direction of the groove-shaped flow path, and is open over an entire length in the direction of the central axis.

7. The pressure control device according to claim 1, wherein the filter member is in a circular cylindrical shape.

8. The pressure control device according to claim 1, wherein the widened part comprises a receiving part which is formed to have a depth larger than a depth of the groove part and which a part of the filter unit enters.
